(19) United States
(12) Patent Application Publication
(10) Pub. No.: US 2007/0079550 A1
(43) Pub. Date: Apr. 12, 2007

(54) Artificial Seed Racks

(76) Inventors: William C. Carlson, Olympia, WA (US); Michael K. McKinnis, Chehalis, WA (US); Paul G. Gaddis, Seattle, WA (US)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 11/465,973

(22) Filed: Aug. 21, 2006

Related U.S. Application Data
(60) Provisional application No. 60/720,256, filed on Sep. 23, 2005.

(51) Int. Cl. A01C 1/06

(52) U.S. Cl. 47/57.6

(57) ABSTRACT

A seed rack (20) for use in assembling artificial seeds is provided. The seed rack includes base (22) having a length and a plurality of receptacles (26). Each one of the plurality of receptacles is sized and configured to receive at least one artificial seed coat (28) having an opening. The seed rack also includes a retaining arm (24) attached to the base for reciprocating movement between an open position and a closed position. In the closed position, the retaining arm clamps the at least one artificial seed coat within one of the plurality of receptacles and assists in positioning the opening of the at least one artificial seed coat within the seed rack.

### CROSS REFERENCE TO RELATED APPLICATION

The present application claims the benefit of U.S. Provisional Application No. 60/720256, filed Sep. 23, 2005.

### FIELD OF THE INVENTION

The present disclosure relates generally to artificial seeds and, more particularly, to racks used during the manufacture of artificial seeds.

### BACKGROUND OF THE INVENTION

Modem agriculture, including silviculture, often requires the planting of large numbers of substantially identical plants genetically tailored to grow optimally in a particular locale or to possess certain other desirable traits. Production of new plants by sexual reproduction can be slow and is often subject to genetic recombinational events resulting in variable traits in its progeny. As a result, asexual propagation has been shown for some species to yield large numbers of genetically identical embryos, each having the capacity to develop into a normal plant. Such embryos must usually be further cultured under laboratory conditions until they reach an autotrophic “seedling” state characterized by an ability to produce their own food via photosynthesis, resist desiccation, produce roots able to penetrate soil and fend off soil microorganisms.

Some researchers have experimented with the production of artificial seeds, known as manufactured seeds, in which individual plant somatic or zygotic embryos are encapsulated in a seed coat, such as those disclosed in U.S. Pat. No. 5,701,699, issued to Carlson et al., the disclosure of which is hereby expressly incorporated by reference.

Typical manufactured seeds include a seed coat, a synthetic gametophyte and a plant embryo. The seed coat is suitably a capsule having a closed end and an open end. Synthetic gametophyte is placed within the seed coat, such that the gametophyte substantially fills the seed coat. A cotyledon restraint may be centrally located within the synthetic gametophyte. The cotyledon restraint includes a centrally located cavity extending partially through the length of the cotyledon restraint and sized to receive the plant embryo therein. The well-known plant embryo is approximately 4-7 millimeters in length and roughly 0.5 millimeters in diameter. The plant embryo is typically sealed within the seed coat by a live end seal.

Currently, manufactured seeds are assembled by using a rack that included pins to pinch the sides of a seed coat to hold the seed coat in a desired position. In other embodiments, the seed rack includes a vacuum displaced in the rack itself to hold the seed coat. Although the use of pins and vacuum arms is effective at transporting and handling manufactured seeds, it is not without its problems.

As a non-limiting example, the use of pins required a large amount of manual handling and, therefore, is expensive and not very ergonomic. The use of a vacuum tip requires additional equipment, e.g., the vacuum, and is also fairly expensive to construct and maintain. Therefore, there exists a need for a seed rack that is both ergonomic and relatively inexpensive.

### SUMMARY OF THE INVENTION

A seed rack for use in assembling artificial seeds is provided. The seed rack includes a base having a length and a plurality of receptacles. Each one of the receptacles are sized and configured to receive at least one artificial seed coat having an opening. The seed rack also includes a retaining arm attached to the base for reciprocating movement between an opened position and a closed position. In the closed position, the retaining arm clamps the artificial seed coat within one of the plurality of receptacles and assists in positioning the opening of the artificial seed coat within the seed rack.

Another embodiment of a seed rack constructed in accordance with the present invention includes a base having a plurality of receptacles extending along a surface of the base and a retaining arm. The retaining arm is hingedly coupled to the base for reciprocating movement between an opened position, where at least one artificial seed coat may be placed within one of the plurality of receptacles, and a closed position. In the closed position, the retaining arm assists in positioning the artificial seed coat in a predetermined orientation relative to the base when the artificial seed coat is placed within one of the plurality of receptacles.

A seed rack constructed in accordance with yet another embodiment of the present invention includes a base having at least one receptacle disposed along a longitudinal axis extending through a length of the base and a retaining arm. The retaining arm is pivotally attached to the base for clamping an artificial seed coat within one of the receptacles when an artificial seed coat is placed within the receptacle. The retaining arm assists in aligning an opening in the artificial seed coat along the longitudinal axis.

### BRIEF DESCRIPTION OF THE DRAWINGS

The foregoing aspects and many of the attendant advantages of this invention will become better understood by reference to the following detailed description, when taken in conjunction with the accompanying drawings, wherein:

FIG. 1 is an isometric view of a seed rack constructed in accordance with one embodiment of the present invention;

FIG. 2 is an exploded view of the seed rack of FIG. 1;

FIG. 3 is a side planar view of the seed rack of FIG. 1 and showing a plurality of artificial seeds aligned along a longitudinal axis extending through the seed rack; and

FIG. 4 is an isometric view of a seed rack constructed in accordance with a second embodiment of the present invention.

### DETAILED DESCRIPTION OF THE PREFERRED EMBODIMENT

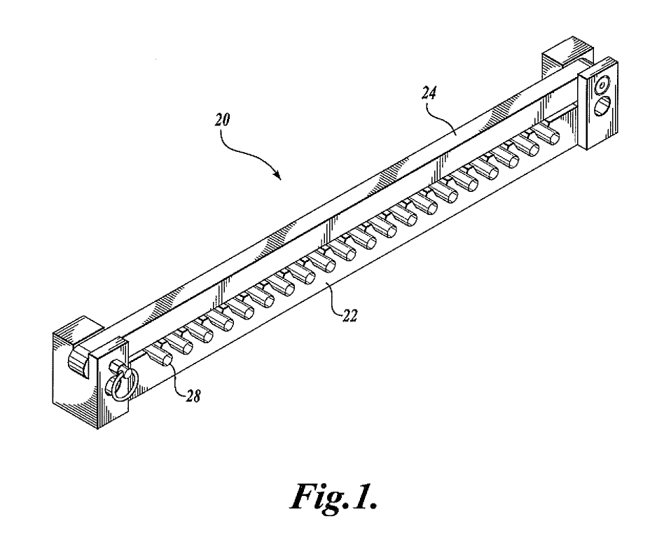

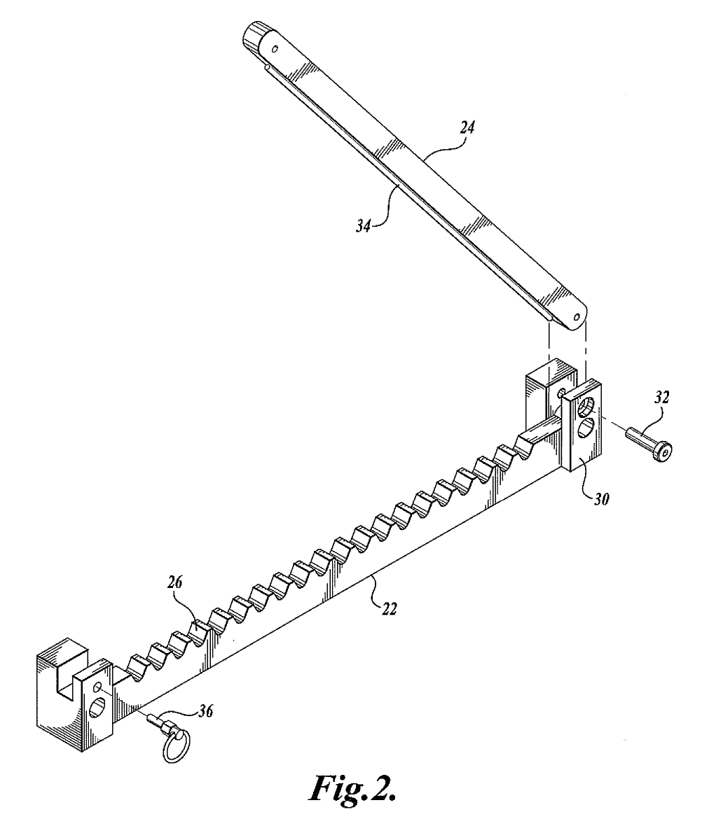

A seed rack 20 constructed in accordance with various embodiments of the present invention may be best understood by referring to FIGS. 1 and 2. The seed rack 20 includes a base 22 and a retaining arm 24. Both the base 22 and the retaining arm 24 are suitably manufactured from any well-known material, such as aluminum. The base 22 includes a plurality of seed receptacles 26.

Each of the seed receptacles 26 are suitably integrally formed in the base 22 and are geometrically sized to receive a seed coat 28. Specifically, and as may be best seen by referring to FIG. 2, the seed receptacles 26 are suitably formed as a serrated portion of the base 22 and positioned on the base 22 such that a longitudinal axis extending through a length of each seed receptacle 26 is substantially perpendicular a corresponding longitudinal axis extending through a length of the base 22. As a result, the seed receptacles 26 are disposed along the length of the base 22 and are positioned normal to the length of the base 22.

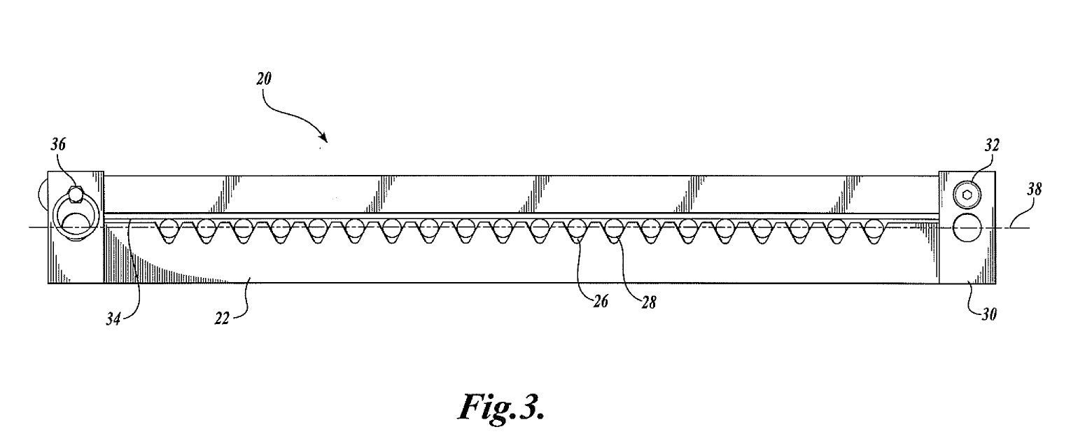

Still referring to FIG. 2, each seed receptacle 26 is preferably V-shaped in cross section with a truncated bottom. This shape assists in positioning and centering a seed coat 28 deposited in a corresponding seed receptacle 26, when the seed rack 20 is in the closed positioned, as described in greater detail below with respect to FIG. 3. Although a seed receptacle 26 having a V-shaped cross section and a truncated bottom is preferred, other shapes, such as V-shaped and U-shaped, are also within the scope of various embodiments of the present invention.

The retaining arm 24 is suitably an elongate bar hingedly attached to a yoke 30 formed with one end of the base 22 by a pin 32. The pin 32 extends through the upright portions of the yoke 30 and through one end of the retaining arm 24 to permit swinging movement of the retaining arm 24 between an open and closed position. In the open position, a seed coat 28 is placed within one of the seed receptacles 26. In the closed position, the retaining arm 24 restrains seed coats 28 placed within a seed receptacle 26 by placing a closing pressure on the seed coat 28 to clamp, without substantially deforming, the seed coat 28 between the seed receptacle 26 and the lower surface of the retaining arm 24. The retaining arm 24 is selectively locked in the closed position by a well-known lock assembly 36, such as a spring loaded pin.

In some embodiments, the lower surface of the retaining arm 24 may include a pad 34. The pad 34 is suitably formed from a strip of silicone tubing and is glued to the lower surface of the retaining arm 24. The purpose of the pad 34 is to cushion the seed coat 28 when it is clamped between the retaining arm 24 and the base 22.

Operation of the seed rack 20 may be best understood by referring to FIG. 3. In use, a seed coat 28 is either automatically or manually placed within one of the seed receptacles 26 formed in the base 22. After as many seed coats 28 as desired are placed into the seed receptacles 26, the retaining arm 24 is locked into the closed position, thereby securing the seed coats 28 within the seed rack 20 by clamping action. As locked within the seed rack 20, each one of the seed coats 28 are aligned along a longitudinal axis 38 extending along the length of the seed rack 20. Specifically, the opening of each seed coat 28 is aligned for further processing, such as placing an embryo within the seed coat.

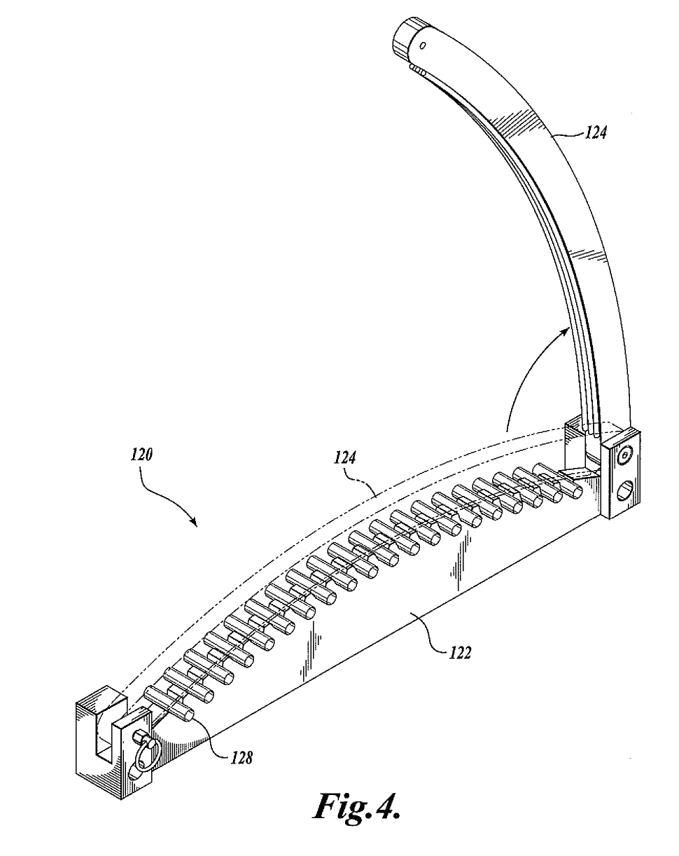

While the preferred embodiment of the invention has been illustrated and described, it will be appreciated that various changes can be made therein without departing from the spirit and scope of the invention. As a non-limiting example, and as may be best seen by referring to FIG. 4, the seed rack 120 includes a base 122 which may be circular or oval in shape. In such configurations, the retaining arm 124 clamps artificial seed coats 128 within the seed rack 120, such that the opening of the seed coats 128 are aligned in a substantially constant circumference. Accordingly, seed racks 120 of varying geometric shapes are also within the scope of the present disclosure.

The embodiments of the invention in which an exclusive property or privilege is claimed are defined as follows:

1. A seed rack for use in assembling artificial seeds, the seed rack comprising:
(a) a base having a length and a plurality of receptacles, each one of the plurality of receptacles sized and configured to receive at least one artificial seed coat having an opening; and
(b) a retaining arm attached to the base for reciprocating movement between an open position and a closed position, where the retaining arm clamps the at least one artificial seed coat within one of the plurality of receptacles and assists in positioning the opening of the at least one artificial seed coat within the seed rack.

2. The seed rack of claim 1, wherein the retaining arm positions the opening of the artificial seed coat along a longitudinal axis extending through the length of the base.

3. The seed rack of claim 1, wherein the retaining arm positions the opening of the artificial seed coat along a substantially constant circumference.

4. The seed rack of the claim 1, wherein the plurality of receptacles are substantially V-shaped in cross section to assist in positioning the at least one artificial seed coat within the seed rack.

5. A seed rack for use in assembling artificial seeds, the seed rack comprising:
(a) a base having a plurality of receptacles extending along a surface of the base, and
(b) a retaining arm hingedly coupled to the base for reciprocating movement between an open position, where at least one artificial seed coat may be placed within one of the plurality of receptacles, and a closed position, where the retaining arm assists in positioning the artificial seed coat in a predetermined orientation relative to the base when the artificial seed coat is placed within one of the plurality of receptacles.

6. The seed rack of claim 5, wherein the predetermined orientation is along a longitudinal axis extending along a length of the base.

7. The seed rack of claim 5, wherein the predetermined orientation is along a non-linear axis extending through a length of the base.

8. The seed rack of claim 5, wherein the predetermined orientation is along a circumference defined by the base.

9. The seed rack of claim 5, wherein each one of the plurality of receptacles has a predetermined cross section to assist in positioning the artificial seed coat in a predetermined orientation relative to the base when the artificial seed coat is placed within one of the plurality of receptacles.

10. The seed rack of claim 9, wherein the predetermined cross section is substantially U-shaped.

11. A seed rack for use in assembling artificial seeds, the seed rack comprising:
(a) a base having at least one receptacle disposed along a longitudinal axis extending through a length of the base; and
(b) a retaining arm pivotably attached to the base for clamping an artificial seed coat within the at least one receptacle when an artificial seed coat is placed within the at least one receptacle, the retaining arm assisting in aligning an opening in the artificial seed coat along the longitudinal axis.

12. The seed rack of claim 11, wherein the at least one receptacle is geometrically configured to assist in aligning an artificial seed coat within the at least one receptacle when an artificial seed coat is placed within the at least one receptacle.

13. The seed rack of claim 12, wherein the at least one receptacle is substantially V-shaped in cross section.
